(19) United States
(12) Patent Application Publication
(10) Pub. No.: US 2025/0256444 A1
(43) Pub. Date: Aug. 14, 2025

(54) DRIVE DEVICE FOR AN INJECTION DEVICE

(71) Applicant: ENGEL AUSTRIA GmbH, Schwertberg (AT)

(72) Inventors: Florian POROD, St. Valentin (AT); Markus OTTO, Ernsthofen (AT)

(21) Appl. No.: 19/047,168

(22) Filed: Feb. 6, 2025

(30) Foreign Application Priority Data
Feb. 12, 2024 (AT) A 50108/2024

(51) Int. Cl. B29C 45/53; B29C 45/82

(52) U.S. Cl. CPC B29C 45/531; B29C 45/82; B29C 2945/76006; B29C 2945/76013; B29C 2945/76096; B29C 2945/762

(57) ABSTRACT

A drive device includes an output for an injection piston of an injection device to be acted upon to generate an injection force, a hydraulic drive mechanically connected to the output for the injection piston, and an electric drive. The electric drive is mechanically connected to the output for the injection piston via the hydraulic drive, so that the drive force generated by the electric drive can be transmitted together with the drive force generated by the hydraulic drive via the hydraulic drive to the output for actuating the injection piston. The electric drive is at least partially integrated into the hydraulic drive, and has an electric motor and a coupling device. The coupling device of the electric drive is arranged completely in a cylinder of the hydraulic drive.

### BACKGROUND OF THE INVENTION

The present invention relates to a drive device for an injection device, an injection device with at least one such drive device, and an injection molding machine with at least one such injection device.

It is known to transmit the injection force required for injection to the injection piston by means of an output, which is connected to both a hydraulic drive and an electric drive (for example EP 760 277 B1 and WO 2016/050002 A1). Such drive devices have a long construction.

It is an object to provide a drive device, an injection device with at least one such drive device and an injection molding machine with at least one such injection device, which have a shorter construction compared to the prior art.

### SUMMARY OF THE INVENTION

This object is achieved by a drive device as described below, an injection device having at least one such drive device, and an injection molding machine having at least one such injection device.

Such a drive device has at least:
an output for an injection piston of an injection device to be acted upon in order to generate an injection force,
at least one hydraulic drive mechanically connected to the output for the injection piston, and
at least one electric drive. The electric drive is mechanically connected to the output for the injection piston via the hydraulic drive, so that the drive force generated by the electric drive can be transmitted together with the drive force generated by the hydraulic drive via the hydraulic drive to the output for actuating the injection piston

In such a drive device, the electric drive is only mechanically connected to the output through the hydraulic drive, so that the entire drive force generated by the electric drive can be transferred to the output for the injection piston together with the drive force generated by the hydraulic drive. Because the at least one electric drive is at least partially integrated into the at least one hydraulic drive, the result is a design that is reduced in length compared to the prior art.

Preferably, the at least one hydraulic drive comprises a piston-cylinder unit with a piston mounted in a cylinder. The cylinder is divided into two chambers by the piston. One of these chambers is filled with pressurized hydraulic oil to generate force. In the case of a double-acting piston-cylinder unit, both chambers are filled with oil; in the case of a single-acting piston-cylinder unit, only one chamber is filled with oil.

If the at least one hydraulic drive has a piston-cylinder unit with a piston mounted in a cylinder, in one exemplary embodiment the at least one electric drive is at least partially integrated into the at least one hydraulic drive in such a way that the at least one electric drive is at least partially arranged in the cylinder of the at least one hydraulic drive (in the case of a single-acting piston-cylinder unit, preferably not in the chamber which is filled with pressurized hydraulic oil to generate force). Preferably, the piston has a recess for receiving a part of the at least one electric drive.

Furthermore, the at least one electric drive has at least one electric motor and a coupling device. A rotary movement of the electric motor can be converted into a linear movement by the coupling device, for example in the form of a spindle drive with a spindle and a spindle nut, and preferably the spindle nut is arranged in a rotationally fixed manner and the spindle can be rotated by the electric motor. For example, the spindle nut can be connected to the piston in a rotationally fixed manner.

In one embodiment, the spindle drive is designed as a ball screw drive.

The coupling device of the at least one electric drive is integrated into the at least one hydraulic drive. Preferably, the piston has a recess for receiving a part of the at least one electric drive.

If the at least one electric drive has at least one electric motor and a coupling device and the at least one hydraulic drive has a piston-cylinder unit with a piston mounted in a cylinder, at least the coupling device of the at least one electric drive is arranged completely in the cylinder of the at least one hydraulic drive. The piston can have a recess for receiving a part of the coupling device.

In one embodiment, the piston has a piston plate and a piston rod connected thereto or formed in one piece therewith. If the piston has a recess for receiving part of the coupling device, this can extend through the piston plate over a large part of the length of the piston rod.

For example, the output can be formed from the at least one cylinder of the hydraulic drive, possibly an injection block, a spindle of a spindle drive and an electric motor of the at least one electric drive.

Preferably, the drive device is a drive device for an injection unit for a plastic injection molding machine, the injection unit is an injection unit for a plastic injection molding machine, and the injection molding machine is a plastic injection molding machine.

### BRIEF DESCRIPTION OF THE DRAWINGS

Various embodiments will be discussed below with reference to the drawings, in which:

FIG. 1 is a partial sectional view of a first embodiment in a first operating position,

FIG. 2 is a partial sectional view of the first embodiment in a second operating position,

FIG. 3 is a partial sectional view of a second embodiment in the first operating position, and

FIG. 4 is a longitudinal view of a third embodiment.

### DETAILED DESCRIPTION OF THE INVENTION

The embodiments described below are examples in the case of processing of plastic. Differently from what has been discussed, the plasticization of the plastic material can take place spatially separated from the injection cylinder.

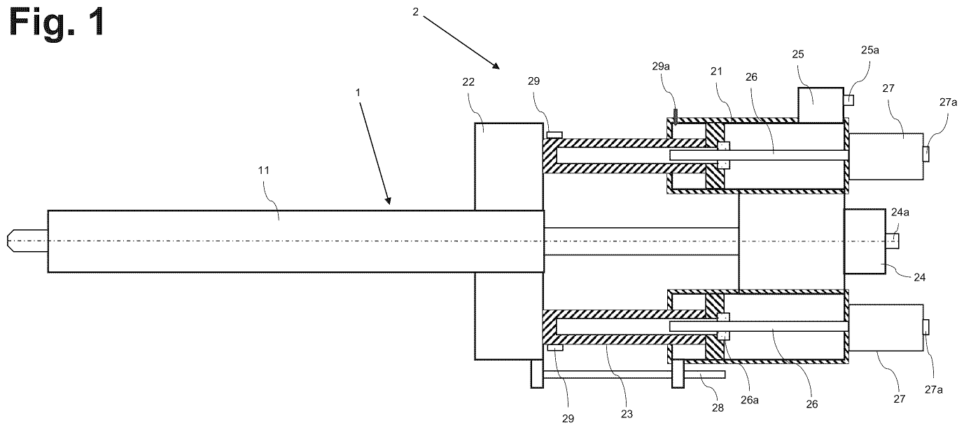

FIG. 1 shows an injection device 1 with a drive device 2.

In the embodiments discussed, the plastic material is plasticized by a plasticizing screw (not visible) arranged in the injection cylinder 11 in a dosing process (in which it is rotated by a dosing motor 24; an optional encoder 24a for the dosing motor 24 is also shown), which plastic material is then injected into a mold cavity (not shown) by the plasticizing screw acting as an injection piston. The injection force required for injection is generated by the drive device 2. Unlike the configuration shown, a piston could be arranged in the injection cylinder 11, which piston injects already plasticized melt into a mold cavity.

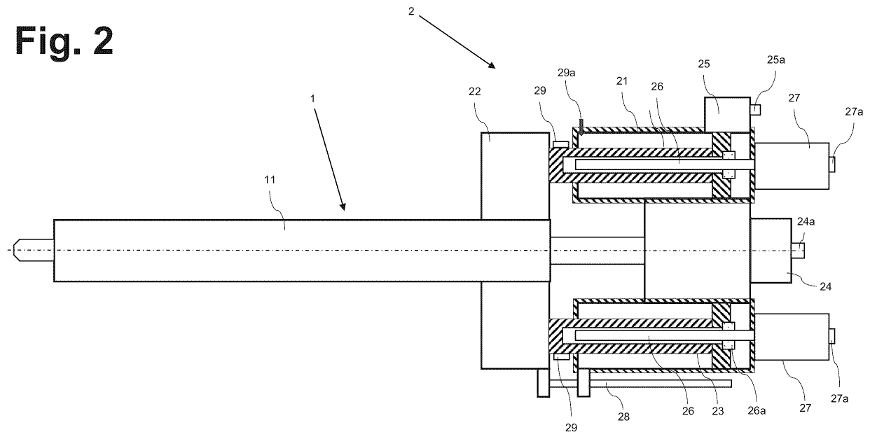

The drive device 2 has an injection block, two hydraulic drives 21, 23 and two electric drives 26, 26a, 27. For injection, cylinder 21 together with the components arranged thereon is pulled towards the stationary carrier plate 22 and the injection cylinder 11 fixed thereto (i.e. it is moved to the left in FIGS. 1 and 2).

The hydraulic drives 21, 23 have a cylinder 21 and a piston 23 movably arranged in the cylinder 21. In this embodiment, the piston-cylinder units are single-acting units.

The piston 23 has a piston plate and a piston rod connected thereto. Alternatively, a one-piece configuration is possible.

The piston 23 has a recess for receiving a part of the coupling device (here-depending on the respective operating position-a part of the spindle 26 and a part of the spindle nut 26a), which extends through the piston plate over a large part of the length of the piston rod. In the piston plate, the recess can have a wider part in which the spindle nut 26a is at least partially arranged, and a narrower part which serves for the passage of the spindle 26. Since the piston 23 is single-acting in this embodiment, the coupling device does not come into contact with hydraulic oil.

To partially generate the injection force (that portion which is to be supplied by the hydraulic drive 21, 23), the chamber of the piston 23 which is located closer to the injection cylinder 11 is filled with hydraulic oil via lines not shown. The piston 23 is mechanically connected to a carrier plate 22. The temperature of the hydraulic oil can be detected via a temperature sensor 29a.

The electric drives 26, 26a, 27 have an electric motor 27 (optional encoders 27a are also shown) and a coupling device in the form of a spindle drive 26, 26a with a spindle 26 and a spindle nut 26a. The spindle nut 26a is connected to the piston 23 in a rotationally fixed manner. The spindle 26 can be rotated by the electric motor 27. This rotary movement is converted into a linear movement of the spindle nut 26a, whereby the cylinder 21 is pulled towards the stationary carrier plate 22, so that the portion of the injection force to be applied by the electric drive 26, 26a, 27 is transferred together with the portion of the injection force to be applied by the hydraulic drive 21, 23 to the output and thus to the injection piston.

An injection stroke can be determined via a distance sensor 28, which in this embodiment is connected both to the carrier plate 22 and to one of the cylinders 21.

By means of a first force measuring device 25a (here in the form of a pressure sensor), the contribution of the hydraulic drive 21, 23 to the injection force can be measured.

The total injection force can be measured by a second force measuring device 29 (here in the form of a strain gauge).

The first force measuring device 25a and the second force measuring device 29 can be provided together or alternatively. If both are provided, the difference can be used to determine the contribution of the electric drive 26, 26a, 27 to the injection force. Alternatively or additionally, the contribution of the electric drive 26, 26a, 27 to the injection force can be measured from a measurement of the current absorbed by the electric motor 27.

The hydraulic drives 21, 23 and the electric drives 26, 26a, 27 can be synchronized in a known manner, for example in the form of a synchronous control.

The electric motors 27 can be controlled or regulated by a control or regulating device (not shown) to apply a dynamic pressure and to carry out a screw retraction. The first operating position shown in FIG. 1 corresponds the state before injection.

The distance between the output and the carrier plate 22 is maximum. The injection cylinder 11, the carrier plate 22 and the pistons 23 connected to the carrier plate 22 are arranged in a stationary manner. If those chambers of the hydraulic drives which are located closer to the injection cylinder 11 and the carrier plate 22 (the left chambers in FIGS. 1 and 2) are now filled with pressurized hydraulic oil, the injection piston which is firmly connected to the cylinders 21 via the output is moved for injection (to the left in FIGS. 1 and 2).

In the second operating position shown in FIG. 2, injection has just taken place. The distance between the output and the carrier plate 22 is at a minimum. By introducing hydraulic oil into the cylinders 21 in a manner coordinated with the driving of the spindle nuts 26a by the electric motors 27 and the spindles 26, the injection force was generated partly by the electric drives 26, 26a, 27 and partly by the hydraulic drives 21, 23 and transmitted to the output only via the hydraulic drives 21, 23 (here via their pistons 23).

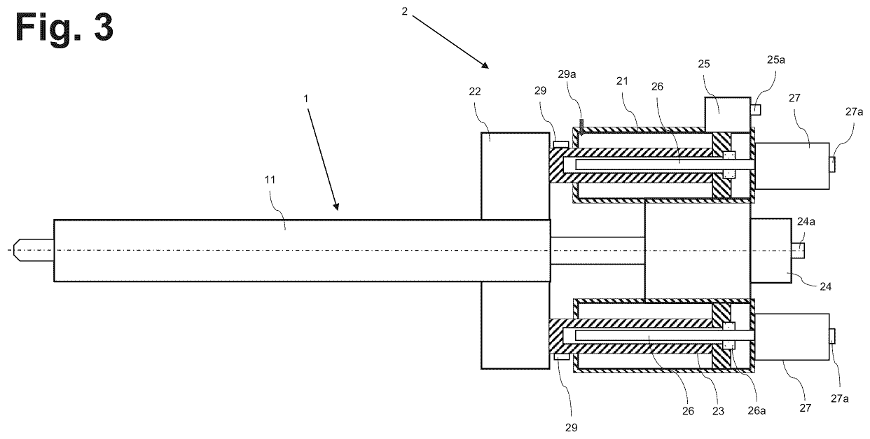

In the second embodiment shown in FIG. 3, no distance sensor is provided. Here (possibly also additionally or alternatively in the other embodiments) a distance measurement can be carried out via an encoder (27a) of the at least one electric motor (27).

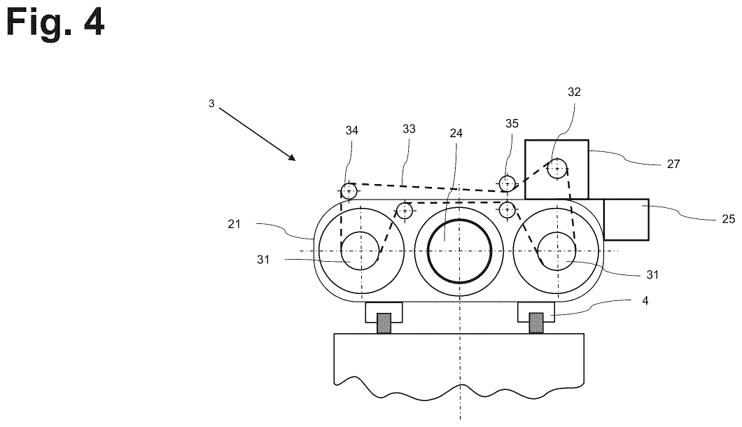

FIG. 4 shows a third embodiment in which an electric drive 26, 26a, 27 is provided, wherein the force of an electric motor 27 is transmitted to the spindles 26 via a belt drive 3. Otherwise, this embodiment is identical to the first or second embodiment.

The belt drive 3 has a toothed pulley 31, a pinion 32 connected to the electric motor 27 and a toothed belt 33 for transmitting the rotary movement to the spindles 26. A deflection pulley 34 and a tension pulley 35 are provided for the toothed belt 33.

FIG. 4 shows a guide unit 4 that can be provided in all embodiments.

### REFERENCE NUMERALS

1 injection device
11 injection cylinder
2 drive device for the injection device
21 cylinder of the hydraulic drive
22 carrier plate
23 piston of the hydraulic drive
24 dosing motor
24a encoder
25 injection block
25a first force measuring device
26 spindle of the spindle drive
26a spindle nut of the spindle drive
27 electric motor
27a encoder
28 distance sensor
29 second force measuring device
29a temperature sensor
3 belt drive
31 toothed disc
32 pinion
33 toothed belt
34 pulley
35 tension pulley
4 guide unit

1. A drive device for an injection device, comprising:
an output for an injection piston of an injection device to be acted upon in order to generate an injection force,
at least one hydraulic drive mechanically connected to the output for the injection piston,
at least one electric drive, wherein the electric drive is mechanically connected to the output for the injection piston via the hydraulic drive, so that the drive force generated by the electric drive can be transmitted together with the drive force generated by the hydraulic drive via the hydraulic drive to the output for actuating the injection piston,
wherein the at least one electric drive is at least partially integrated into the at least one hydraulic drive, wherein the at least one electric drive has at least one electric motor and a coupling device, wherein at least the coupling device of the at least one electric drive is arranged completely in a cylinder of the at least one hydraulic drive.

2. The drive device according to claim 1, wherein the at least one hydraulic drive has a piston- cylinder unit with a piston mounted in a cylinder.

3. The drive device according to claim 2, wherein a rotary movement of the electric motor can be converted into a linear movement by the coupling device.

4. The drive device according to claim 1, wherein the coupling device is formed by a spindle drive with a spindle and a spindle nut, wherein it is preferably provided that the spindle nut is arranged in a rotationally fixed manner and the spindle is rotatable by the electric motor.

5. The drive device according to claim 4, wherein the spindle drive is a ball screw drive.

6. The drive device according to claim 2, wherein the at least one electric drive is at least partially integrated into the at least one hydraulic drive in such a way that the at least one electric drive is at least partially arranged in the cylinder of the at least one hydraulic drive.

7. The drive device according to claim 1, wherein the at least one electric drive is at least partially integrated into the at least one hydraulic drive in such a way that at least the coupling device of the at least one electric drive is integrated into the at least one hydraulic drive.

8. The drive device according to claim 2, wherein:
at least one second force measuring device for detecting an injection force is arranged on the piston of the at least one hydraulic drive, and/or
a distance measurement is carried out via an encoder of the at least one electric motor.

9. The drive device according to claim 2, wherein the cylinder of the at least one hydraulic drive is designed as a single-acting cylinder.

10. The drive device according to claim 1, wherein a control or regulating device is provided by which the at least one hydraulic drive and/or the at least one electric motor can be controlled or regulated for applying a dynamic pressure and for carrying out a screw retraction.

11. The drive device according to claim 1, wherein:
at least one distance sensor is provided for measuring an injection stroke, and/or
a distance measurement is carried out via an encoder of the at least one electric motor.

12. An injection device for an injection molding machine with at least one drive device according to claim 1.

13. An injection molding machine with at least one injection device according to claim 12.
